(19) United States
(12) Patent Application Publication
(10) Pub. No.: US 2018/0367719 A1
(43) Pub. Date: Dec. 20, 2018

(54) CAMERA MODULE AND METHOD FOR ASSEMBLING CAMERA MODULE

(71) Applicant: Primax Electronics Ltd., Taipei (TW)

(72) Inventors: Han-Kai Wang, Taipei (TW); Wei-Chih Teng, Taipei (TW); Chin-Ding Lai, Taipei (TW)

(21) Appl. No.: 15/811,618

(22) Filed: Nov. 13, 2017

(30) Foreign Application Priority Data
Jun. 16, 2017 (TW) 106120246

(51) Int. Cl. H04N 5/225; G06T 7/00; G06T 7/13

(52) U.S. Cl. CPC H04N 5/2257; H04N 5/2254; G06T 2207/30148; G06T 7/13; G06T 7/001

(57) ABSTRACT

The present invention relates to a camera module, including an induction wafer and a non-circular lens. The induction wafer has an induction area. The non-circular lens is located above the induction wafer and covers the induction area, so that an external light ray can pass through the non-circular lens to be projected to the induction area. The non-circular lens is formed by cutting off a part of a circular lens, so as to generate a small-sized camera module. Therefore, the camera module of the present invention can be accommodated in a narrow space of a portable electronic device.

### FIELD OF THE INVENTION

The present invention relates to a camera module, and in particularly, to a camera module disposed in a portable electronic device.

### BACKGROUND OF THE INVENTION

Small-sized portable electronic devices such as a mobile communications apparatus and a personal digital assistant (PDA) that have a photographing function are becoming increasingly popular. In addition, because the portable electronic devices are small in size and easily carried, the photographing function has become a basic function of the portable electronic device. Therefore, a camera module may be disposed in the portable electronic device.

The following describes a structure of a conventional camera module. Referring to FIG. 1, FIG. 1 is a schematic top view of a partial structure of a conventional camera module. The camera module 1 mainly includes an optical lens 10 and an induction wafer 11. The optical lens 10 is disposed above the induction wafer 11, and is used for refracting an external light ray and enabling the external light ray to pass through, so as to perform imaging. The induction wafer 11 has an induction area 111, and the optical lens 10 covers a range of the induction area 111, so that the induction area 111 can receive the external light ray that passes through the optical lens 10, and the external light ray can be imaged on the induction area 111, so as to generate an image. The optical lens 10 has a circular shape. In addition to the optical lens 10 and the induction wafer 11, the camera module 1 may further include other elements such as a voice coil actuator or an anti-handshake module. These elements are not subjects of this solution, and details are not described herein.

With the evolution of eras, users pay more attention to the photographing function of portable electronic devices, especially to front-facing camera modules in the portable electronic devices. The front-facing camera modules can provide a self-photographing function. Therefore, users attach great importance to photographing effects of the front-facing camera modules, especially to the requirements on pixel values. Usually, the users may require the pixel values of the front-facing camera modules to reach ten millions of pixels or more. Therefore, the volume of high-pixel front-facing camera modules may be increased. In another aspect, the users usually require that the portable electronic devices need to have large-sized display panels. The large-size display panels may reduce internal spaces of the portable electronic devices. Consequently, the high pixel front-facing camera modules are difficult to be disposed in the portable electronic devices.

Therefore, a small-sized and high-pixel camera module is required.

### SUMMARY OF THE INVENTION

An objective of the present invention is to provide a small-sized and high-pixel camera module.

In a preferred embodiment, the present invention provides a camera module disposed in a narrow space of a portable electronic device. The camera module includes an induction wafer and a non-circular lens. The induction wafer has an induction area used for receiving an external light ray to form an image. The non-circular lens is located above the induction wafer and covers the induction area, so that the external light ray can pass through the non-circular lens to be projected to the induction area, where a curved edge length of the non-circular lens is less than a diagonal length of the induction area.

In a preferred embodiment, the present invention provides a method for assembling a camera module, including the following steps: (A) A non-circular lens and an induction wafer are provided, where the induction wafer has an induction area. (B) The non-circular lens is aligned with the induction wafer, so that the non-circular lens can cover the induction area, where a curved edge length of the non-circular lens is less than a diagonal length of the induction area. (C) The non-circular lens and the induction wafer are encapsulated to form the camera module. (D) The camera module is disposed in a narrow space of a portable electronic device.

In a preferred embodiment, the step (B) includes the following steps: (B1) A long side edge of the non-circular lens is aligned with a long side edge of the induction wafer. (B2) A setting angle of the non-circular lens is adjusted by using an active alignment technology.

In a preferred embodiment, the step (B1) includes the following steps: (B1-1) The non-circular lens is moved, so that the non-circular lens is located right above the induction wafer. (B1-2) The non-circular lens and the induction wafer are photographed by using an automatic optic inspection (AOI), to obtain a first edge image corresponding to the non-circular lens and a second edge image corresponding to the induction wafer. (B1-3) It is determined whether the first edge image is aligned with the second edge image.

In a preferred embodiment, the step (B2) includes the following steps: (B2-1) The setting angle of the non-circular lens is adjusted. (B2-2) An external light ray is enabled to pass through the non-circular lens and to be projected to the induction area, so as to generate an image. (B2-3) It is determined whether the image is qualified.

### BRIEF DESCRIPTION OF THE DRAWINGS

FIG. 1 is a schematic top view of a partial structure of a conventional camera module;

FIG. 2 is an exploded schematic top view of a partial structure of a camera module according to a preferred embodiment of the present invention;

FIG. 3 is a schematic top view of a partial structure of a camera module according to a preferred embodiment of the present invention;

FIG. 4A and FIG. 4B are a schematic block diagram of a method for assembling a camera module according to a preferred embodiment of the present invention;

FIG. 5 is a schematic block diagram of a machine for assembling a camera module according to a preferred embodiment of the present invention; and

FIG. 6 is a schematic structural diagram of a camera module that is disposed in a portable electronic device according to a preferred embodiment of the present invention.

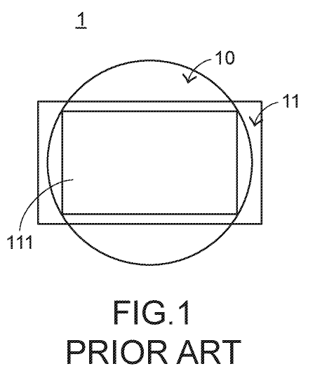

### DETAILED DESCRIPTION OF THE PREFERRED EMBODIMENT

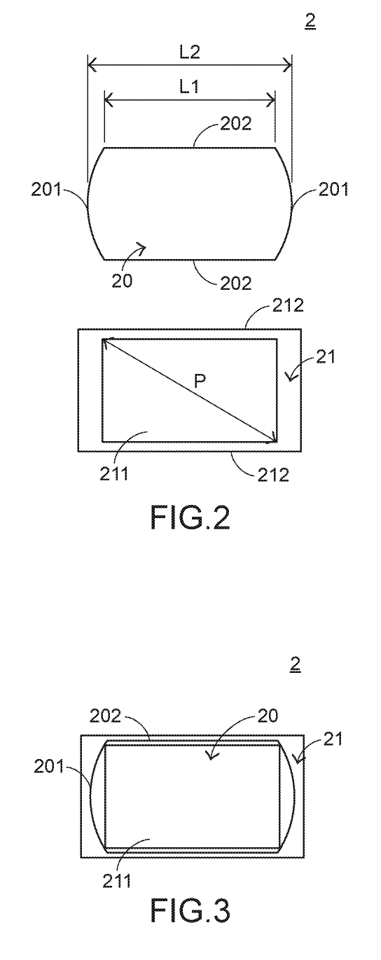

In view of the problems in the conventional technology, the present invention provides a camera module for resolving the problems in the conventional technology. A structure of the camera module of the present invention is first described. Referring to FIG. 2 and FIG. 3 together, FIG. 2 is an exploded schematic top view of a partial structure of a camera module according to a preferred embodiment of the present invention; and FIG. 3 is a schematic top view of a partial structure of a camera module according to a preferred embodiment of the present invention. The camera module 2 includes a non-circular lens 20 and an induction wafer 21. The induction wafer 21 has an induction area 211 used for receiving an external light ray to form an image, where a diagonal length of the induction area 211 is P. The non-circular lens 20 is located above the induction wafer 21 and covers the induction area 211. By using this architecture, the external light ray can pass through the non-circular lens 20 to be projected to the induction area 211. The non-circular lens 20 includes two curved edges 201 and two long side edges 202. A length of the long side edge 202 is L1, and a maximum length of the non-circular lens 20 (that is, a maximum length between the two curved edges 201) is L2. In this preferred embodiment, the non-circular lens 20 has an approximately oval shape.

FIG. 3 shows that the non-circular lens 20 covers the induction area 211, so that the external light ray can be projected to the induction area 211 after passing through the non-circular lens 20. A curved edge length of the non-circular lens 20 (that is, a length of the curved edge 201) is less than the diagonal length P of the induction area 211, the long side edge length L1 of the non-circular lens 20 (that is, a length of the long side edge 202) is less than the diagonal length P of the induction area 211, and the maximum length L2 of the non-circular lens 20 is at least equal to the diagonal length P of the induction area 211. It should be particularly noted that, the non-circular lens 20 is formed by cutting off local edges at the upper and lower sides of a circular lens. Therefore, a maximum length L2 of the non-circular lens 20 is a diameter of the circular lens.

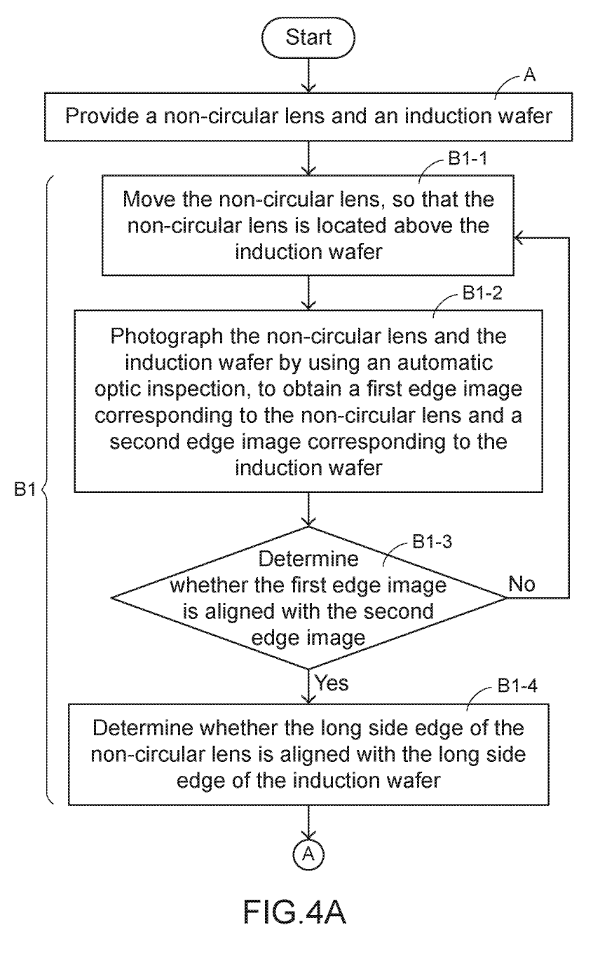

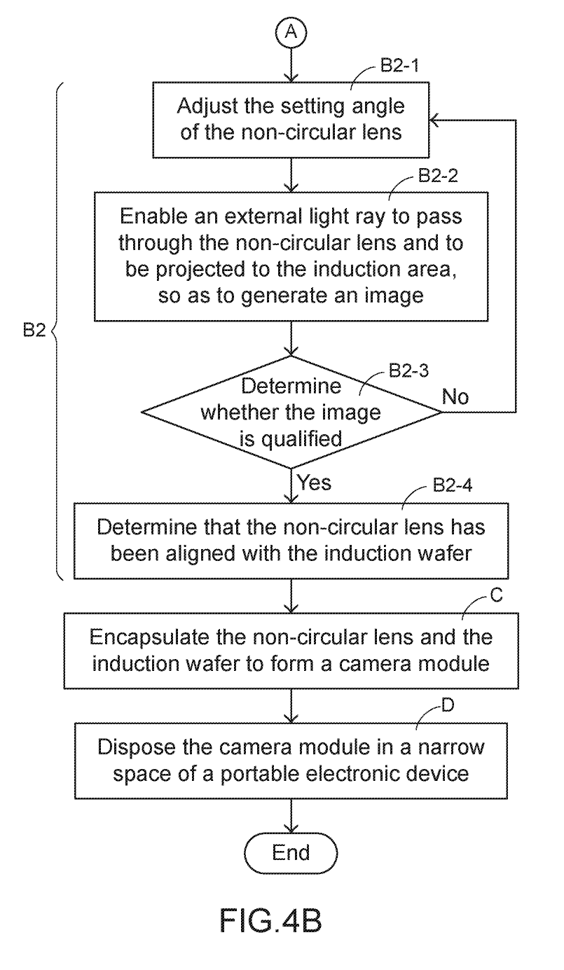

The following describes a method for assembling a camera module 2 in the present invention. Referring to FIG. 4A and FIG. 4B together, FIG. 4A and FIG. 4B are a schematic block diagram of a method for assembling a camera module according to a preferred embodiment of the present invention. The method for assembling a camera module includes the following steps:

Step A: Provide a non-circular lens and an induction wafer.

Step B: Align the non-circular lens with the induction wafer, so that the non-circular lens can cover an induction area of the induction wafer.

Step C: Encapsulate the non-circular lens and the induction wafer to form a camera module.

Step D: Dispose the camera module in a narrow space of a portable electronic device.

The step B includes the following steps:

Step B1: Align a long side edge of the non-circular lens with a long side edge of the induction wafer.

Step B2: Adjust a setting angle of the non-circular lens by using an active alignment technology.

The step B1 includes the following steps:

Step B1-1: Move the non-circular lens, so that the non-circular lens is located above the induction wafer.

Step B1-2: Photograph the non-circular lens and the induction wafer by using an automatic optic inspection, to obtain a first edge image corresponding to the non-circular lens and a second edge image corresponding to the induction wafer.

Step B1-3: Determine whether the first edge image is aligned with the second edge image.

Step B1-4: Determine whether the long side edge of the non-circular lens is aligned with the long side edge of the induction wafer.

The step B2 includes the following steps:

Step B2-1: Adjust the setting angle of the non-circular lens.

Step B2-2: Enable an external light ray to pass through the non-circular lens and to be projected to the induction area, so as to generate an image.

Step B2-3: Determine whether the image is qualified.

Step B2-4: Determine that the non-circular lens has been aligned with the induction wafer.

In the step B1-3, when it is determined that the first edge image has been aligned with the second edge image, the step B1-4 is performed; otherwise, the step B1-1 is performed again. In the step B2-3, when it is determined that the image is qualified, the step B2-4 is performed; otherwise, the step B2-1 is performed again.

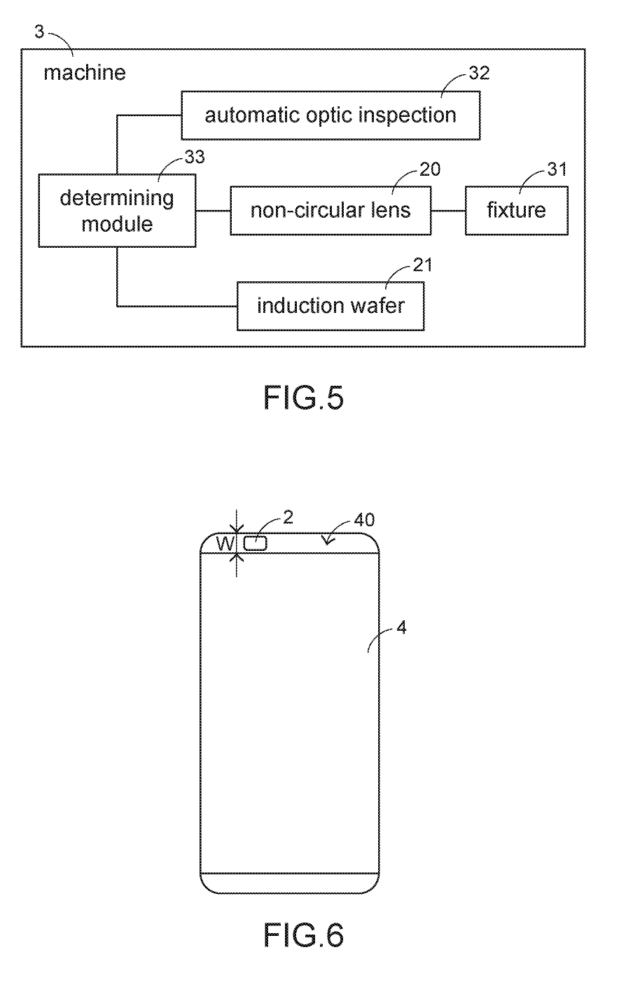

Referring to FIG. 2, FIG. 4A, FIG. 4B, and FIG. 5 together, FIG. 5 is a schematic block diagram of a machine for assembling a camera module according to a preferred embodiment of the present invention. FIG. 5 shows a machine 3 for assembling a camera module 2. The machine 3 includes a fixture 31, an automatic optic inspection 32, and a determining module 33. The fixture 31 is configured to clamp a non-circular lens 20, so as to adjust a setting location and a setting angle of the non-circular lens 20. The machine 3 further includes a power component (not shown in the figure). The power component is connected to the fixture 31, so as to provide power for the fixture 31 and enable the fixture 31 to move or rotate. The automatic optic inspection 32 is configured to photograph the non-circular lens 20 and the induction wafer 21, so as to assist an alignment between the non-circular lens 20 and the induction wafer 21. The determining module 33 is connected to the automatic optic inspection 32 and the induction wafer 21, and is configured to determine whether the non-circular lens 20 and the induction wafer 21 meet a standard configuration from an optical aspect and from a structure aspect. Operation of the automatic optic inspection 32 and the determining module 33 is described subsequently in detail.

In the method for assembling a camera module 2, the step A is first performed: providing the non-circular lens 20 and the induction wafer 21, as shown in FIG. 2. Then, the step B1-1 is performed by using the fixture 31: moving the non-circular lens 20, so that the non-circular lens 20 is located above the induction wafer 21. After the non-circular lens 20 is located above the induction wafer 21, the non-circular lens 20 and the induction wafer 21 are photographed by using the automatic optic inspection 32, to obtain the first edge image corresponding to the long side edge 202 of the non-circular lens 20 and the second edge image corresponding to the long side edge 212 of the induction wafer 21; that is, the step B1-2 is performed. Because the determining module 33 is connected to the automatic optic inspection 32, the determining module 33 may obtain the first edge image corresponding to the non-circular lens 20 and the second edge image corresponding to the induction wafer 21, so as to perform the step B1-3: determining whether the first edge image is aligned with the second edge image. That is, the determining module 33 may determine whether the long side edge 202 of the non-circular lens 20 is aligned with the long side edge 212 of the induction wafer 21 by means of the step B1-3, so as to meet a structure standard. In this preferred embodiment, the determining whether the long side edge 202 of the non-circular lens 20 is aligned with the long side edge 212 of the induction wafer 21 is based on that whether the long side edge 202 of the non-circular lens 20 is aligned with the long side edge 212 of the induction wafer 21 in the horizontal direction.

When determining that the first edge image has been aligned with the second edge image, the determining module 33 performs the step B1-4: determining that the long side edge 202 of the non-circular lens 20 has been aligned with the long side edge 212 of the induction wafer 21. When the determining module 33 determines that the first edge image is not aligned with the second edge image, the step B1-1 is performed again; that is, the non-circular lens 20 may be moved again according to a relative location between the first edge image and the second edge image. After the moving is completed, the step B2-2 to the steps B2-3 are performed again until it is determined that the first edge image has been aligned with the second edge image.

After the step B1 is completed, the step B2-1 is performed by using the fixture 31: adjusting the setting angle of the non-circular lens 20. After the adjustment of the setting angle of the non-circular lens 20 is completed, the step B2-2 continues to be performed: enabling the external light ray to pass through the non-circular lens 20 and to be projected to the induction area 211, so as to generate the image corresponding to the setting angle. Because the determining module 33 is connected to the induction wafer 21, the determining module 33 can obtain the image corresponding to the setting angle, and can perform the step B2-3: determining whether the image is qualified. In this way, the determining module 33 can determine whether the setting angle of the non-circular lens 20 meets an optical standard.

In the step B2-3, when determining that the image is qualified, the determining module 33 performs the step B2-4: determining that the non-circular lens 20 has been aligned with the induction wafer 21. When the determining module 33 determines that the image is not qualified, the step B2-1 is performed again; that is, the determining module 33 may determine whether the setting angle is appropriate according to the current image generated according to the setting angle of the non-circular lens 20. If the setting angle is not appropriate, the step B2-1 to step B2-3 are repeatedly performed until the image corresponding to the setting angle is qualified. When the step B is completed, it indicates that an image surface of the non-circular lens 20 has covered the induction area 211 of the induction wafer 21.

After the step B is completed, the step C is performed: encapsulating the non-circular lens 20 and the induction wafer 21 to form the camera module 2. Operation of setting another component in the camera module 2 is known to persons skilled in the art, and details are not described herein. Lastly, the step D is performed: disposing the camera module 2 in the narrow space 40 of the portable electronic device 4, where a width W of the narrow space 40 is less than a diagonal length P of the induction area 211, as shown in FIG. 6.

It should be particularly noted that, a maximum length L2 of the non-circular lens 20 is a diameter of a circular lens that is not cut off. The maximum length L2 of the non-circular lens 20 is at least equal to the diagonal length P of the induction area 211. Therefore, a size of a camera module that is assembled by using the circular lens that is not cut off is definitely greater than the width W of the narrow space 40. Consequently, the camera module cannot be accommodated in the narrow space 40. Therefore, by using a structure of the cut non-circular lens 20, the camera module 2 of the present invention can be actually accommodated in the narrow space 40 of the portable electronic device 4, so as to resolve problems in the conventional technology.

The foregoing descriptions are merely preferred embodiments of the present invention, and are not intended to limit the scope of the present invention. Any equivalent change or modification made without departing from the spirit of the present invention should fall within the scope of the present invention.

What is claimed is:

1. A camera module, disposed in a narrow space of a portable electronic device, the camera module comprising:
an induction wafer, having an induction area used for receiving an external light ray to form an image; and
a non-circular lens, located above the induction wafer and covering the induction area, so that the external light ray can pass through the non-circular lens to be projected to the induction area, wherein a curved edge length of the non-circular lens is less than a diagonal length of the induction area.

2. The camera module according to claim 1, wherein a long side edge length of the non-circular lens is less than the diagonal length of the induction area, and a maximum length of the non-circular lens is at least equal to the diagonal length of the induction area.

3. The camera module according to claim 1, wherein the non-circular lens has an approximately oval shape.

4. The camera module according to claim 1, wherein a width of the narrow space of the portable electronic device is less than the diagonal length of the induction area.

5. A method for assembling a camera module, comprising the following steps:
(A) providing a non-circular lens and an induction wafer, wherein the induction wafer has an induction area;
(B) aligning the non-circular lens with the induction wafer, so that the non-circular lens can cover the induction area, wherein a curved edge length of the non-circular lens is less than a diagonal length of the induction area;
(C) encapsulating the non-circular lens and the induction wafer to form a camera module; and
(D) disposing the camera module in a narrow space of a portable electronic device.

6. The method for assembling a camera module according to claim 5, wherein the step (B) comprises the following steps:
(B1) aligning a long side edge of the non-circular lens with a long side edge of the induction wafer; and
(B2) adjusting a setting angle of the non-circular lens by using an active alignment technology.

7. The method for assembling a camera module according to claim 6, wherein the step (B1) comprises the following steps:
(B1-1) moving the non-circular lens, so that the non-circular lens is located above the induction wafer;
(B1-2) photographing the non-circular lens and the induction wafer by using an automatic optic inspection, to obtain a first edge image corresponding to the non-circular lens and a second edge image corresponding to the induction wafer; and
(B1-3) determining whether the first edge image is aligned with the second edge image.

8. The method for assembling a camera module according to claim 7, wherein in the step (B1-3), when it is determined that the first edge image is aligned with the second edge image, it is determined that the long side edge of the non-circular lens has been aligned with the long side edge of the induction wafer; and when it is determined that the first edge image is not aligned with the second edge image, the non-circular lens is moved again according to the first edge image and the second edge image.

9. The method for assembling a camera module according to claim 6, wherein the step (B2) comprises the following steps:
(B2-1) adjusting the setting angle of the non-circular lens;
(B2-2) enabling an external light ray to pass through the non-circular lens and to be projected to the induction area, so as to generate an image; and
(B2-3) determining whether the image is qualified.

10. The method for assembling a camera module according to claim 9, wherein in the step (B2-2), when it is determined that the image is qualified, it is determined that the non-circular lens has been aligned with the induction wafer; and when it is determined that the image is not qualified, the setting angle of the non-circular lens is adjusted again.
